(19) United States
(12) Patent Application Publication
(10) Pub. No.: US 2016/0361892 A1
(43) Pub. Date: Dec. 15, 2016

(54) FOAM SHEATHING REINFORCED WITH HYBRID LAMINATED FABRIC IMPREGNATED WITH VAPOR PERMEABLE AIR BARRIER MATERIAL AND METHOD OF MAKING AND USING SAME

(71) Applicant: Romeo Ilarian Ciuperca, Atlanta, GA (US)

(72) Inventor: Romeo Ilarian Ciuperca, Atlanta, GA (US)

(21) Appl. No.: 15/218,729

(22) Filed: Jul. 25, 2016

Related U.S. Application Data
(63) Continuation of application No. 15/180,002, filed on Jun. 11, 2016.
(60) Provisional application No. 62/175,240, filed on Jun. 13, 2015.

(51) Int. Cl. B32B 5/02; B32B 5/20; E04B 1/62; B32B 5/26; E04B 1/80; E04B 1/76; B32B 5/12; B32B 5/24

(52) U.S. Cl. CPC B32B 5/028; B32B 5/022; B32B 5/12; B32B 5/20; B32B 5/245; B32B 5/26; E04B 1/80; E04B 1/762; E04B 1/625; B32B 2262/101; B32B 2266/0278; B32B 2266/0228; B32B 2307/304; B32B 2307/7242; B32B 2307/724; B32B 2419/00

(57) ABSTRACT

The invention comprises a product. The product comprises a foam insulating panel having a first primary surface and an opposite second primary surface and a laminated fabric attached to the first primary surface of the foam insulating panel. The laminated fabric is impregnated with an air-resistant, water-resistant, vapor permeable, elastomeric polymeric material, wherein the air-resistant, water-resistant, vapor permeable elastomeric polymeric material has an elongation factor of greater than 100%, a water vapor transmission rating of at least 0.1 perm and an air permeance of less than 0.004 cfm/sq. ft. under a pressure differential of 0.3 inches of water, whereby the air-resistant, water-resistant, vapor permeable elastomeric polymeric material provides a water-resistant, vapor permeable air barrier. The laminated fabric comprises a woven or nonwoven carrier portion and a woven or nonwoven reinforcing portion attached to the carrier portion. A method of making a composite sheathing panel is also disclosed.

### CROSS-REFERENCE TO RELATED APPLICATIONS

This application is a continuation of application Ser. No. 15/180,002 filed Jun. 11, 2016, which claims the benefit of application Ser. No. 62/175,240 filed Jun. 13, 2015.

### FIELD OF THE INVENTION

The present invention generally relates to an insulated sheathing panel. More particularly, this invention relates to a system for insulating structures, such as residential and commercial buildings. The present invention also relates to a polyisocyanurate insulated sheathing product. The present invention also relates to an insulated sheathing that is an air barrier but allows vapor transmission. The present invention relates to a polyisocyanurate foam panel with improved structural properties. The present invention relates to a reinforced foam panel with improved air and weather barrier properties. The present invention also relates to making a reinforced foam panel fire resistant. The present invention also relates to a polyisocyanurate insulated sheathing in which the vapor permeability can be varied. The present invention also related to a reinforcing framing element to enhance the performance of insulated sheathing. The present invention also relates to a method of insulating structures, such as residential and commercial buildings.

### BACKGROUND OF THE INVENTION

In buildings, energy loss takes place primarily through the building envelope. The building envelope consists of doors, windows, and exterior wall and roofing systems.

To improve energy efficiency, and to control air infiltration and exfiltration, building codes have recently required the use of air barriers on the exterior sheathing along with use of continuous foam insulation. Air barriers are required on the exterior sheathing to eliminate air exchange. The important features of an air barrier system are: continuity, structural support, air impermeability, and durability. An air barrier has to be continuous and must be interconnected to seal all other elements such as windows, doors and penetrations. Effective structural support requires that any component of an air barrier system must resist the positive or negative structural loads that are imposed on that component by wind, stack effect, and HVAC fan pressures without rupture, displacement or undue deflection. This load must then be safely transferred to the structure. Materials selected to be part of an air barrier system should be chosen with care to avoid materials that are too air-permeable, such as fiberboard, perlite board, and uncoated concrete block. The air permeance of a material is measured using ASTM E 2178 test protocol and is reported in Liters/second per square meter at 75 Pa pressure (cfm/ft² at 0.3″ w.g or 1.57 psf). The Canadian and IECC codes and ASHRAE 90.1-2010 consider 0.02 L/s·m² 75 Pa (0.004 cfm/ft² at 1.57 psf), which happens to be the air permeance of a sheet of ½″ unpainted gypsum wall board, as the maximum allowable air leakage for a material that can be used as part of an air barrier system for an opaque enclosure. In order to achieve an airtight structure, the basic materials selected for the air barrier must be highly air-impermeable. The U.S. Army Corps of Engineers (USACE) and the Naval Facilities Command (NAVFAC) have established 0.25 cfm/ft² at 1.57 psf (1.25 L/s·m² at 75 Pa) as the maximum air leakage for an entire building (airflow tested in accordance with the USACE/ABAA Air Leakage Test Protocol, which incorporates ASTM E 779); whereas the U.S. Air Force and the International Green Construction Code (IgCC) specify 0.4 cfm/ft² at 1.57 psf ((2.0 L/s·m²@ 75 Pa) divided by the area of the enclosure pressure boundary). Materials selected for an air barrier system must perform their function for the expected life of the structure; otherwise they must be accessible for periodic maintenance.

An air barrier, unlike the vapor retarder (which stops air movement, but does not control diffusion), can be located anywhere in an enclosure assembly. If it is placed on the predominantly warm, humid side (high vapor pressure side) of an enclosure or building, it can control diffusion as well, and should be a low-perm vapor barrier material. In such case, it is called an “air and vapor barrier.” If placed on the predominantly cool, drier side (low vapor pressure side) of an enclosure or building, it should be vapor permeable (5-10 perms or greater).

Air barriers can have different vapor permeability ratings. Various building codes bodies classify them as vapor permeable, vapor barriers (vapor impermeable) and vapor retarders (vapor semi-permeable). Elastomeric vapor permeable air barrier have a vapor permeability rating of at least 1-10 perms. Vapor impermeable air barriers have a vapor permeability rating of less than 0.1 perms. Vapor retardant air barriers have a vapor permeability rating of between 0.1 perms and 1 perm.

The ASHRAE Standard 90.1 classifies the 50 states of the USA in at least 8 distinct climate zones. Building codes require a continuous air barrier membrane over the exterior of a building and a continuous foam insulation layer over the structural framing members in all climate zones. However depending on the climate zone, the air barrier requirement can be any one of the three discussed above. For example in hot climates, such a Zones 2 and 3, an air barrier has to be vapor permeable, while in very cold climate, such as Zone 7, an air barrier has to be vapor impermeable. These various factors make it challenging to product manufacturers, designers and contractors to provide the proper solution for each location.

Elastomeric products used currently as air membranes meet all of the above concerns. Air membranes stop air and water but allow water vapors under pressure differential. They are designed to resist stresses and rupture. The code requires that air membranes have an elongation factor of at least 300%. Aluminum foils are used to laminate many types of sheathing products, such as plywood or foam. By code aluminum foil faced products cannot be used in applications where vapor permeability is required. It would be of great benefit if an air barrier could have heat reflective properties; i.e., infrared and heat reflective properties similar to the aluminum foils and in addition meet all code mandated requirement.

Thermal performance of the building envelope influences the energy demand of a building in two ways. It affects annual energy consumption, and, therefore, the operating costs for building heating, cooling, and humidity control.

As can be seen, an air barrier system and building insulation are essential components of the building envelope so that air pressure relationships within the building can be controlled, building HVAC systems can perform as intended, and the occupants can enjoy healthy indoor air quality and a comfortable environment, while reducing energy consumption.

Polyisocyanurate insulation board is used as insulated board in exterior building construction. Polyisocyanurate insulation board is made by extruding thermosetting polyisocyanurate foam with a blowing agent between two facers while being exposed to elevated temperatures to accelerate the cure the polyisocyanurate foam. Generally there are two types of facing materials used for this application. Glass fibers and aluminum foil facers can withstand the curing temperatures required in the thermosetting process. Glass mat facers are made of randomly dispersed glass fibers formed into a fabric. The glass mat fibers provide some level of reinforcing to the foam panel. However due to the random orientation of the fibers, the mat is not very strong in tension or flexure and the foam panel made therewith can relatively easily be torn or ripped apart. It would be desirable that these foam panels have improved structural properties. While the glass mat fiber facer has some water repellant properties, it doesn't meet the minimum vapor and air permeability standards required by the new building codes.

To meet all of the above challenges in each climate zone and application and to keep cost down, it would be desirable to provide an exterior sheathing product that has an air barrier membrane built into it. It also would be advantageous if the air barrier membrane properties could be adjusted to achieve any desired vapor permeability value; i.e., from a high vapor permeability rating to a low vapor permeable rating to a vapor impermeability rating. It would be desired for the air barrier sheathing to have insulating properties. It would also be desirable that the exterior insulating sheathing product is structurally sound and can resist the positive or negative structural loads that are imposed on a building without rupture, displacement or undue deflection. It is desirable that these loads are safely transferred to the associated structure. It would be desirable that the exterior sheathing product has fire resistant properties. The construction industry would benefit tremendously from a sheathing product that has built into it all of the above properties required by building codes. Such a sheathing product would eliminate the current use of multiple products and reduce labor, time and cost of installation.

### SUMMARY OF THE INVENTION

The present invention satisfies the foregoing needs by providing an improved insulating system for structures, such as residential and commercial buildings.

In one disclosed embodiment, the present invention comprises a product. The product comprises a foam insulating panel having a first primary surface and an opposite second primary surface and a laminated fabric attached to the first primary surface of the foam insulating panel. The laminated fabric is impregnated with an air-resistant, water-resistant, vapor permeable, elastomeric polymeric material, wherein the air-resistant, water-resistant, vapor permeable elastomeric polymeric material has an elongation factor of greater than 100%, a water vapor transmission rating of at least 0.1 perm and an air permeance of less than 0.004 cfm/sq. ft. under a pressure differential of 0.3 inches of water, whereby the air-resistant, water-resistant, vapor permeable elastomeric polymeric material provides a water-resistant, vapor permeable air barrier. The laminated fabric comprises a woven or nonwoven carrier portion and a woven or nonwoven reinforcing portion attached to the carrier portion.

In another disclosed embodiment, the present invention comprises a method. The method comprises applying an uncured thermal insulating polymer foam to a first primary surface of laminated fabric, wherein the laminated fabric is impregnated with an air-resistant, water-resistant, vapor permeable, elastomeric polymeric material, wherein the air-resistant, water-resistant, vapor permeable elastomeric polymeric material has an elongation factor of greater than 100%, a water vapor transmission rating of at least 0.1 perm and an air permeance of less than 0.004 cfm/sq. ft. under a pressure differential of 0.3 inches of water, whereby the air-resistant, water-resistant, vapor permeable elastomeric polymeric material provides a water-resistant, vapor permeable air barrier and wherein the laminated fabric comprises a woven or nonwoven carrier portion and a woven or nonwoven reinforcing portion attached to the carrier portion. The method also comprises at least partially curing the thermal insulating polymer foam.

In another disclosed embodiment, the present invention comprises a product. The product comprises a polyisocyanurate foam panel having a first primary surface and an opposite second primary surface, wherein the foam panel has a thickness of greater than or equal to 1 inch. The product also comprises a laminated fabric attached to the first primary surface of the polyisocyanurate foam insulating panel, wherein the laminated fabric is impregnated with an air-resistant, water-resistant, vapor permeable, elastomeric polymeric material, wherein the air-resistant, water-resistant, vapor permeable elastomeric polymeric material has an elongation factor of greater than 100%, a water vapor transmission rating of at least 0.1 perm and an air permeance of less than 0.004 cfm/sq. ft. under a pressure differential of 0.3 inches of water, whereby the air-resistant, water-resistant, vapor permeable elastomeric polymeric material provides a water-resistant, vapor permeable air barrier. The laminated fabric comprises a first nonwoven carrier layer having a primary surface, a laid scrim or mesh attached to the primary surface of the carrier layer and an optional second carrier layer attached to the laid scrim so that the laid scrim or mesh is disposed between the first and second nonwoven carrier layers.

Accordingly, it is an object of the present invention to provide an improved insulating building system.

Another object of the present inventions is to provide an insulating board that is vapor permeable but prevents air leakage through a building envelope.

Another object of the present inventions is to provide a reinforced foam panel and sheathing material with improved insulating and fire resistance properties.

Another object of the present inventions is to provide a reinforced foam panel and sheathing material with improved structural properties.

Another object of the present inventions is to provide a reinforced foam panel and sheathing material with improved insulating and fire resistance properties

Another object of the present invention is to provide a reinforced foam panel with improved properties that can be used as a substrate for exterior wall claddings

Another object of the present invention is to provide insulated foam sheathing for use in insulating structures, such as residential and commercial buildings.

Another object of the present invention is to provide insulated foam sheathing for use in insulating roofs.

Another object of the present invention is to provide an improved method for insulating structures, such as residential and commercial buildings.

A further object of the present invention is to provide a more efficient way of insulating structures, such as residential and commercial buildings.

Another object of the present invention is to provide an improved system for attaching foam sheathing panels to a building structure.

Another object of the present invention is to provide an improved insulated sheathing system in which the vapor permeability can be varied; i.e., increased or decreased.

Another object of the present invention is to provide an improved insulated sheathing system that prevents water intrusion.

Yet another object of the present invention is to provide an improved air and water resistive vapor permeable elastomeric polymer impregnated laminated fabric reinforcement membrane attached to a foam insulating panel.

These and other objects, features and advantages of the present invention will become apparent after a review of the following detailed description of the disclosed embodiments and the appended drawing and claims.

### BRIEF DESCRIPTION OF THE DRAWINGS

FIG. 1 is a partial cross-sectional side view of a disclosed embodiment of a foam insulating panel in accordance with the present invention.

FIG. 2 is a partial top plan view of a laminated fabric in accordance with the present invention, showing an over/under yarn orientation.

FIG. 3 is a schematic view of a disclosed embodiment of an apparatus for applying a vapor permeable polymer to a layer of reinforcing material in accordance with the present invention.

FIG. 4 is a schematic view of a disclosed embodiment of an apparatus for preparing insulating a foam panel in accordance with the present invention.

FIG. 5 is a top plan view of a porous laminated fabric in accordance with the present invention.

FIG. 6 is a partial cross-sectional view taken along the line 22-22 of the porous laminated fabric shown in FIG. 21.

FIG. 7 is a partial top plan view of a laid scrim in accordance with the present invention, showing side-by-side yarn orientation.

FIG. 8 is a partial top plan view of a laid scrim in accordance with the present invention, showing an over/under yarn orientation.

FIG. 9 is a partial top plan view of a laid scrim in accordance with the present invention, showing a tri-directional yarn orientation.

FIG. 10 is a partial top plan view of a laid scrim in accordance with the present invention, showing a quad-directional yarn orientation.

FIG. 11 is a partially cut away perspective view of a disclosed embodiment of an insulated wall sheathing system in accordance with the present invention.

FIG. 12 is a partial detailed plan view of the exterior surface of the composite insulated panel shown in FIG. 1 showing a layer of reinforcing material at least partially disposed under a washer and a screw for attaching the composite insulated panel to a building structure.

FIG. 13 is a partial cross-sectional view taken along the line 3-3 of the insulated wall sheathing system shown in FIG. 1.

### DETAILED DESCRIPTION OF THE DISCLOSED EMBODIMENTS

U.S. Pat. No. 8,966,845 and U.S. patent application Ser. No. 14/847,152 filed Sep. 8, 2015, are both incorporated herein by reference in their entirety.

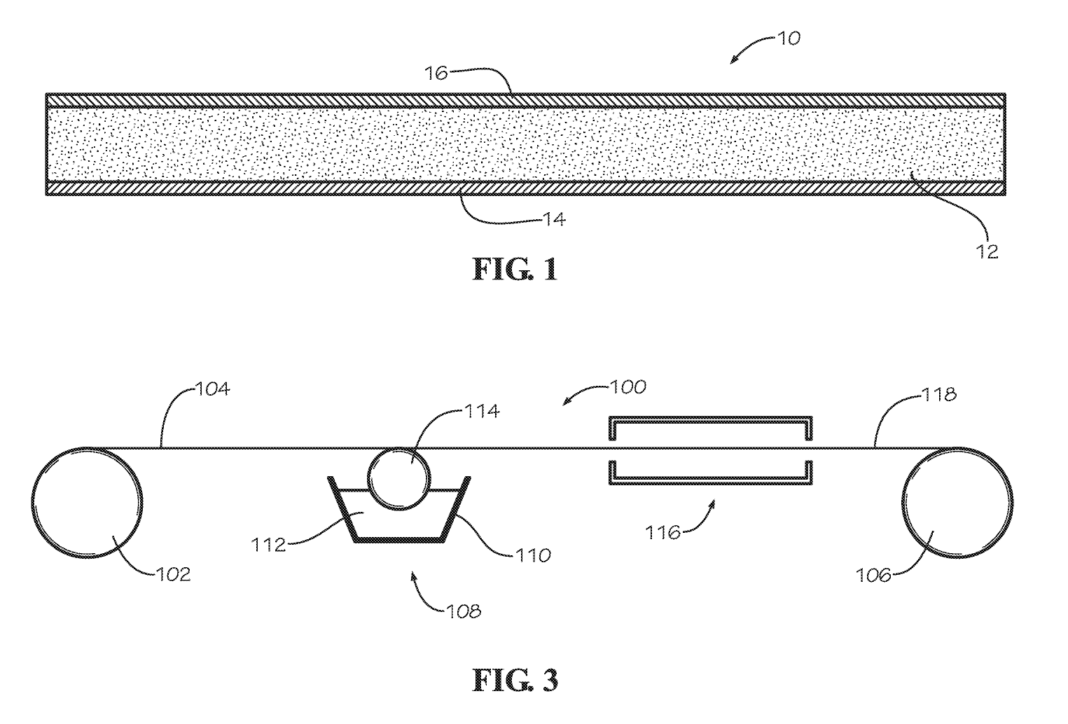

Referring now to the drawing in which like numbers indicate like elements throughout the several views, there is shown in FIG. 1 a disclosed embodiment of composite foam insulated sheathing board 10 for providing thermal insulation to a building structure. The composite foam insulated sheathing board 10 in accordance with the present invention comprises a thermal insulating polymer foam core 12 to which is attached a first layer of laminated fabric membrane 14 on at least one side of the thermal insulating polymer foam core. Optionally, attached to the opposite side of the polymer foam core 12 is a second layer of porous reinforcing fabric 16, which may be the same as the first layer of laminated fabric membrane 14 or it may be different, such as a woven or nonwoven porous material, for example a nonwoven fiberglass mat.

The first layer of elastomeric polymer laminated fabric membrane 14 has at least two portions. The first portion is a woven or nonwoven carrier portion 18. The second portion is a woven or nonwoven mesh or scrim 20 of reinforcing elements including, but not limited to, filaments, fibers, strands or yarns, having high tensile strength relative to the carrier layer 18 and the foam core 12 and having an open construction. The first carrier portion 18 is attached to the second mesh or scrim portion 20. Optionally, there is a third woven or nonwoven carrier portion 22 attached to the second mesh or scrim layer 20 so that the second mesh or scrim layer is disposed between the first carrier layer 18 and third carrier layer. Importantly, the laminated fabric 14 is impregnated with an air-resistant, water-resistant, vapor permeable, elastomeric polymer to thereby provide a water-resistant, vapor permeable air barrier membrane.

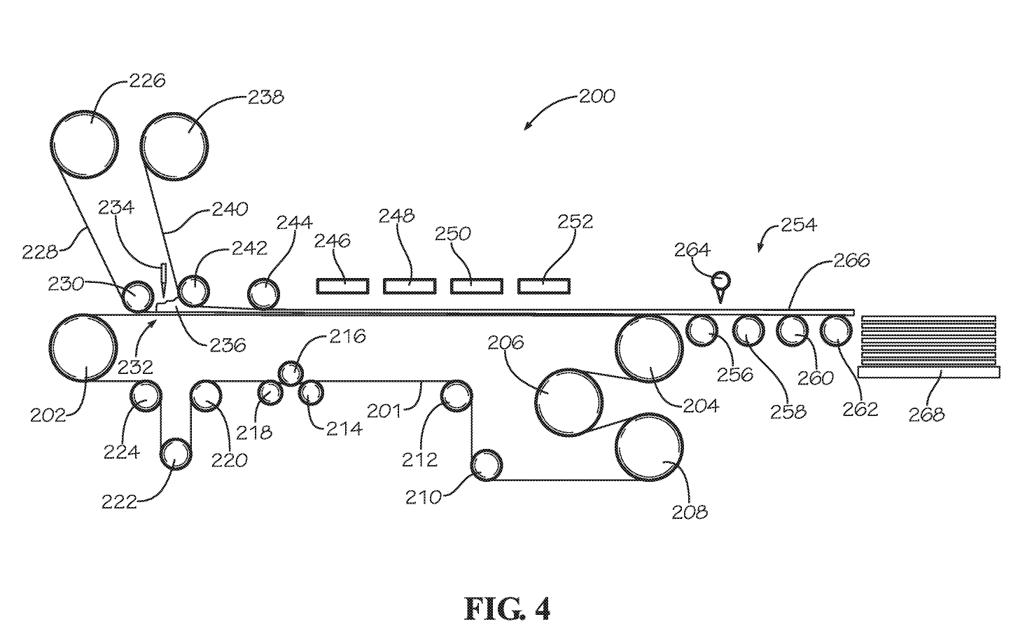

FIGS. 3 and 4 shows an apparatus 100 for applying an air-resistant, water-resistant, vapor permeable, elastomeric polymer to a laminated fabric 104 or to a woven or nonwoven porous reinforcing material. FIG. 3 shows a supply roll 102 of laminated fabric 104. A single layer of laminated fabric 104 is moved from the supply roll 102 to a take-up roll 106 by a drive mechanism (not shown). The laminated fabric 104 moves from the supply roll 102 to a polymer applicator station 108. The polymer application station 108 includes a trough 110 filled with a liquid elastomeric polymer 112 that when applied to the laminated fabric 104 and cured renders the impregnated laminated fabric air-resistant, waterproof or water resistant while still being vapor permeable. The polymer application station 108 also includes a rotatable applicator roller 114 rotatably driven by a motor (not shown). When the laminated fabric 104 passes over the rotating applicator roller 114, the liquid elastomeric polymer 112 in the trough 110 is transferred to the underside of the laminated fabric membrane 14 by the applicator roller. The speed that the applicator roller 114 turns and the speed of the laminated fabric 104 over the applicator roller can be adjusted to vary the amount of liquid polymer 112 applied to the nonwoven fiberglass depending on the particular polymer used and the particular materials from which the laminated fabric 104 is made. This polymer application may vary from a surface coating to preferably fully impregnating the laminated fabric 104 with the liquid polymer. All of the foregoing are appropriate for the present invention as long as the appropriate physical properties of the polymer impregnated laminated fabric membrane are achieved; i.e., waterproof, or at least water resistant, air-resistant and vapor permeable to the extent described below. To achieve the desired amount of coating or impregnating of the laminated fabric 104, it is contemplated that the top surface of the laminated fabric can also be coated using a second roll coater (not shown), if necessary. Alternately, the polymer can be applied to the laminated fabric 104 by any other suitable means, such as by spraying, by dipping and the like.

From the polymer application station 108 the now elastomeric polymer impregnated laminated fabric 104 moves to a drying station 116. The drying station 116 can be any suitable means for relatively rapidly drying the liquid polymer applied to the laminated fabric 104 at the polymer application station 108, such as a heated forced air oven, infrared heaters and the like. From the drying station 116, the now elastomeric polymer impregnated laminated fabric membrane 118 moves to the take-up roll 106 where the dry, elastomeric polymer impregnated laminated fabric membrane is rolled into a roll.

FIG. 4 shows a disclosed embodiment of an apparatus 200 for forming composite sheathing panels 10 in accordance with the present invention and comprises an endless conveyor belt 201 extending along an endless conveyor path over four drive rollers 202, 204, 206 and 208, which are driven by an electric motor (not shown), idler rollers 210, 212, belt guide rollers 214, 216, 218 and belt tensioner rollers 220, 222 and 224. The speed of the belt 401 is variably controllable to adjust to varying manufacturing needs.

From the drive roller 202, the conveyor belt 401, which preferably is constructed from Teflon coated fiberglass, is seen to pass around the drive rollers 204, 206, 208. The belt 201 is delivered to the idler rollers 210, 212, to the belt guide rollers 214, 216, 218, the belt tensioner 220, 222, 224 and then back to the drive roller 202.

Positioned above the belt 201 adjacent the drive roller 202 is a supply roll of impregnated laminated fabric membrane 226. The roll of impregnated laminated fabric membrane 226 is preferably the cured, impregnated laminated fabric membrane 118 made by the process described above with respect to FIG. 3, especially the elastomeric polymer impregnated fabric membrane roll 106. An uncoated, porous woven or nonwoven material can also be used as long as the uncoated, porous woven or nonwoven material can support a liquid applied thermal insulating, foam-forming polymer, such as polyisocyanurate or polyurethane, without bleeding completely through the uncoated, porous woven or nonwoven reinforcing material. The thermal insulating, foam-forming polymer preferably forms a closed cell foam. For purposes of illustrating the present invention, the roll of laminated fabric membrane 226 is a cured, polymer-impregnated laminated fabric membrane 228. A single layer of elastomeric polymer impregnated laminated fabric membrane 228 is fed from the supply roll 226, around a roller 230 and onto the belt 201 where it lays flat on the surface of the belt and moves in unison with the belt. The use of an impregnated laminated fabric membrane 226 is preferable because it significantly inhibits or prevents the liquid applied thermal insulating, foamed or foam-forming polymer from striking through the impregnated porous reinforcing material. Of course, the thixotropic properties of the liquid applied thermal insulating, foamed or foam-forming polymer can be adjusted to further prevent the possibility of striking through the impregnated laminated fabric membrane 226.

The impregnated laminated fabric membrane 228 on the belt 201 moves from the roller 230 to a polymer deposition station 232. The polymer deposition station 232 includes a traversing downwardly extending spout 234 disposed above the impregnated laminated fabric membrane 228 on the belt 401. Polymer reactants, such as for example polyisocyanurate or polyurethane, are dispensed into a mixer/frothing machine (not shown). Polymer foam is delivered from the mixer/frothing machine through a flexible hose (not shown) to the spout 234. The spout 234 traverses back and forth across the width of the impregnated laminated fabric membrane 228 on the belt 201 and polymer foam is dispensed from the spout onto the impregnated laminated fabric membrane 14 on the belt. The polymer foam forms a puddle 236 on the upper surface of the impregnated laminated fabric membrane 228. Positioned above the polymer deposition station 232 is a second supply roll of porous reinforcing material 238. The roll of porous reinforcing material 238 can be the same as the impregnated laminated fabric membrane 228, or alternatively can be a porous woven or nonwoven material, such as a nonwoven fiberglass mat. However, an uncoated, porous reinforcing material, as described above, can also be used as long as the uncoated, porous reinforcing material can be applied to the polymer foam 236 without bleeding completely through the uncoated, porous reinforcing material. For the purpose of this disclosed embodiment, the roll of porous reinforcing material is a nonwoven fiberglass mat.

A single layer of nonwoven fiberglass mat 240 is fed from the supply roll 238, around a roller 242 and onto the top of the uncured polymer foam puddle 236. As the foam laden impregnated laminated fabric membrane 228 is drawn under the roller 242, the uncured polymer foam is compressed slightly between the impregnated laminated fabric membrane 228 and the nonwoven fiberglass mat 240. The two layers of elastomeric polymer impregnated laminated fabric membrane 228 and nonwoven fiberglass mat 240, with the polymer foam 236 sandwiched therebetween, move in unison with the motion of the belt 201. The belt 201 then carries the impregnated laminated fabric membrane 228, nonwoven fiberglass mat 240 and polymer foam 236 sandwich under a gauge roller 244 where the sandwich is compressed to a desired thickness, such as approximately 0.5 inches, preferably 1 inch, more preferably approximately 2 inches, most preferably approximately 3 inches, especially approximately 4 inches and all thicknesses between 0.5 inches and 4 inches. The gauged impregnated laminated fabric membrane 228, nonwoven fiberglass mat 240 and polymer foam 236 sandwich then passes under a bank of heaters, such as infrared heaters 246, 248, 250, 252. The heaters 246-252 provide sufficient heat to the uncured polymer foam 236 sandwiched between the impregnated laminated fabric membrane 228 and nonwoven fiberglass mat 240 so that the polymer foam at least partially cures or cures sufficiently so that the foam can support the weight of the sandwich. The polymer foam 236 can be a conventional polyisocyanurate or polyurethane. Optionally, up to 10% by weight carbon black, magnetite, aluminum or metal flakes, mica or graphite or a combination of any of the above, up to a total percentage not to exceed 10% by weight or volume of the total foam polymer can be added to the polyisocyanurate foam or polyurethane foam to increase the heat insulating properties of the composite foam panel 10.

The at least partially cured polymer foam 236 and impregnated laminated fabric membrane 228 and nonwoven fiberglass mat 240 sandwich then moves to a board cutting station 254. The board cutting station 254 includes a plurality of rollers 256, 258, 260, 262 for supporting the impregnated laminated fabric membrane 228 and nonwoven fiberglass mat 240/at least partially cured polymer foam 236 sandwich. The board cutting station 254 also includes a traversing cutting device 264. The cutting device 264 traverses the width of the impregnated laminated fabric membrane 228 and nonwoven fiberglass mat 240/at least partially cured polymer foam 236 sandwich and also moves in unison with the belt 201 while the cutting device is cutting the impregnated laminated fabric membrane 228 and nonwoven fiberglass mat 240/at least partially cured polymer foam 236 sandwich into boards, such as the composite foam insulating sheathing board 266. The cutting device 264 can be a heated knife, a rotating blade, a reciprocating blade, a laser, a water jet and the like. After the boards, such as the composite foam insulating sheathing board 266, are cut from the impregnated laminated fabric membrane 228 and nonwoven fiberglass mat 240/at least partially cured polymer foam 236 sandwich, the boards are stacked on a pallet 268. The pallet 268 of composite foam insulating sheathing boards can then be moved to a storage or shipping area.

If the first and second layers of fabric 14, 16 are not treated with the air-resistant, water-resistant, vapor permeable elastomeric polymer, as described above with respect to FIG. 3, the first and second layers of fabric can be treated with the air-resistant, water-resistant, vapor permeable elastomeric polymer after the composite foam insulating sheathing board has been assembled, as described above with respect to FIG. 4, such as by spraying or roll coating the composite foam insulating sheathing board 10, as shown in FIG. 1, so as to impregnate the first and optionally the second layers of fabric. Both methods produce an air-resistant, water-resistant, vapor permeable foam insulating sheathing board in accordance with the present invention.

Useful liquid applied air-resistant, water-resistant, vapor permeable elastomeric polymer materials (i.e., weather membrane materials) include, but are not limited to, Air-Shield LMP by W.R. Meadows, Cartersville, Ga., USA, (a vinyl acetate and ethylene glycol monobutyl ether acetate water-based air/liquid elastomeric vapor permeable air barrier that cures to form a tough, seamless, elastomeric membrane); Perm-A-Barrier VP 20 by Grace Construction Products, W.R. Grace & Co. (a fire-resistive, one component, fluid-applied elastomeric vapor permeable air barrier membrane that protects building envelope from air leakage and rain penetration, but allow the walls to “breathe”); and Tyvek Fluid Applied WB System by E.I. du Pont de Nemours and Company, Wilmington, Del., USA (a fluid applied weather barrier, vapor permeable system). Air-Shield LMP has an air permeability of <0.04 cfm/ft² @ 75 Pa (1.57 lbs/ft²) (ASTM E2357), an air permeability of <0.004 cfm/ft² @ 75 Pa (1.57 lbs/ft²) (ASTM E2178), water vapor permeance of 12 perms (ASTM E96) and an elongation of 1000% (ASTM D412). Perm-A-Barrier VP 20 has an air permeance of <0.0006 cfm/ft² @ 1.57 psf (0.003 L/s·m² @ 75 Pa) (ASTM E2178).

The weather membrane polymer optionally is made from a combination of the liquid weather membrane material, as described above, and approximately 0.1% to approximately 50% by weight ceramic fibers, preferably approximately 0.1% to approximately 40% by weight, more preferably approximately 0.1% to approximately 30% by weight, most preferably approximately 0.1% to approximately 20% by weight, especially approximately 0.1% to approximately 15% by weight, more especially approximately 0.1% to approximately 10% by weight, most especially approximately 0.1% to approximately 5% by weight. Ceramic fibers are fibers made from materials including, but not limited to, silica, silicon carbide, alumina, aluminum silicate, aluminum oxide, zirconia, calcium silicate or mixtures or combinations thereof. Wollastonite is an example of a ceramic fiber. The above fibers can be used in any number of ways and combination percentages, not just as a single element added to the elastomeric material. Wollastonite is a calcium inosilicate mineral (CaSiO₃) that may contain small amounts of iron, magnesium, and manganese substituted for calcium. Wollastonite is available from NYCO Minerals of NY, USA. Bulk ceramic fibers are available from Unifrax I LLC, Niagara Falls, N.Y., USA. Ceramic fibers are known to block heat transmission and especially radiant heat. Ceramic fibers can help improve the energy efficiency and fire resistance of the elastomeric vapor permeable air barrier membrane and of the composite insulated foam panel.

Optionally, Wollastonite, other mineral oxides, such as magnesium oxide and aluminum oxide, fly ash, rice husk ash or fire clay or any other fire resistant fillers, can be added to the weather membrane polymer, in the above mentioned quantities, to both increase resistance to heat transmission, improve radiant heat insulation properties and act as a fire retardant. Therefore, the weather membrane materials can obtain fire resistance properties. A fire resistant weather membrane over the exterior surface of the composite foam insulating sheathing board can increase the fire rating of the wall assembly and delay the melting of the composite foam insulating sheathing board.

Alternatively, the weather membrane polymer can be made from a combination of the liquid weather membrane material, as described above, and approximately 0.1% to approximately 50% by weight heat reflective elements, preferably approximately 0.1% to approximately 40% by weight, more preferably approximately 0.1% to approximately 30% by weight, most preferably approximately 0.1% to approximately 20% by weight, especially approximately 0.1% to approximately 15% by weight, more especially approximately 0.1% to approximately 10% by weight, most especially approximately 0.1% to approximately 5% by weight. Heat reflective elements are made from materials including, but not limited to, carbon black, mica, aluminum flakes, magnetite, graphite, carbon, other types of silicates or mixtures or combinations thereof. The above heat reflective elements can be used in any number ways and combination percentages, not just as a single element added to the elastomeric material. The heat reflective elements can also be used in conjunction with the ceramic fibers mentioned above in any number of ways and percentage combinations. The weather membrane polymer will thus have infrared or heat reflective properties for improved insulating and energy efficiency properties. Preferably, the weather membrane polymer is water-resistant. Vapor permeable weather and air barriers have to allow the desired amount of vapor transmission under pressure differential but have to stop the water infiltration into the building envelope. It is also preferred that the weather membrane polymer when dried is vapor permeable. Thus, when dried the vapor permeable polymer provides an air barrier, but not a vapor barrier. When dried the vapor permeable polymer preferably has a water vapor transmission rating of at least 0.1 perm (1.0 US perm=1.0 grain/square-foot hour inch of mercury 57 SI perm=57 ng/s·m2·Pa) (ASTM E96), preferably at least 1 perm, more preferably at least 5 perms, most preferably at least 10 perms. When dried the vapor permeable polymer should have an elongation factor of greater than 100%, preferably greater than 200%, more preferably greater than 300%, most preferably greater than 400%, especially greater than 500%, more especially greater than 600%, most especially greater than 700% and an air permeance of less than 0.004 cfm/sq. ft. under a pressure differential of 0.3 in. water (1.57 psf) (equal to 0.02 L/s.×sq. m.@ 75 Pa). Air permeance is measure in accordance with ASTM E2178. The composite insulating foam sheathing board 10 should have an assembly air permeance of less than 0.04 cfm/sq. ft. of surface area under a pressure differential of 0.3 in. water (1.57 psf) (equal to 0.2 L/s.×sq. m. of surface area at 75 Pa) when tested in accordance with ASTM E2357. The weather membrane polymer can be latex, elastomeric, acrylic, and may or may not have fire resistive properties. Air permeance is the amount of air that migrates through a material.

As stated above, first layer of elastomeric polymer impregnated laminated fabric membrane 14 comprises a woven or nonwoven carrier layer 18, a woven or nonwoven reinforcing layer 20 having an open grid construction to provide reinforcement and an optional additional woven or nonwoven carrier layer 22. The reinforcing layer 20 is preferably a laid scrim or grid. Reinforcing elements for the laid scrim can have various configurations including, but not limited to, side-by-side, over/under, tri-directional and quad-directional. The laminated fabric preferably includes at least one nonwoven carrier layer. The laid scrim is bonded to the carrier layer. The carrier layer can be placed on one primary surface of the laid scrim. Or, the carrier layer can be placed on each of the opposite primary surfaces of the laid scrim; i.e., top and bottom surfaces.

The laid scrim comprises a plurality of reinforcing elements, woven or non-woven, in various patterns or configurations provide structural reinforcement to the carrier layer while the carrier layer provides embedment and impregnating surface support for the weather membrane polymer to achieve the air-resistant, water-resistant, vapor permeable elastomeric polymer impregnated fabric membrane for the facing of the foam insulating sheathing boards described in the present invention. While the carrier layers are usually made from the same material, they can also be made from different material. For example, one carrier layer could be a woven material and the other carrier layer could be a nonwoven material. Alternatively, the carrier layer and the reinforcing layer could be woven together. For example, the carrier layer can be a nonwoven material and the reinforcing layer can be a woven material, which during the weaving process, some of the filaments, strands or yarns of the woven reinforcing material penetrate the nonwoven carrier portion forming a unitary reinforcing and carrier material. Alternatively, pieces of nonwoven material could be inserted in between the filaments, strands or yarns of the reinforcing layer to form a combined carrier layer and reinforcing layer in one layer.

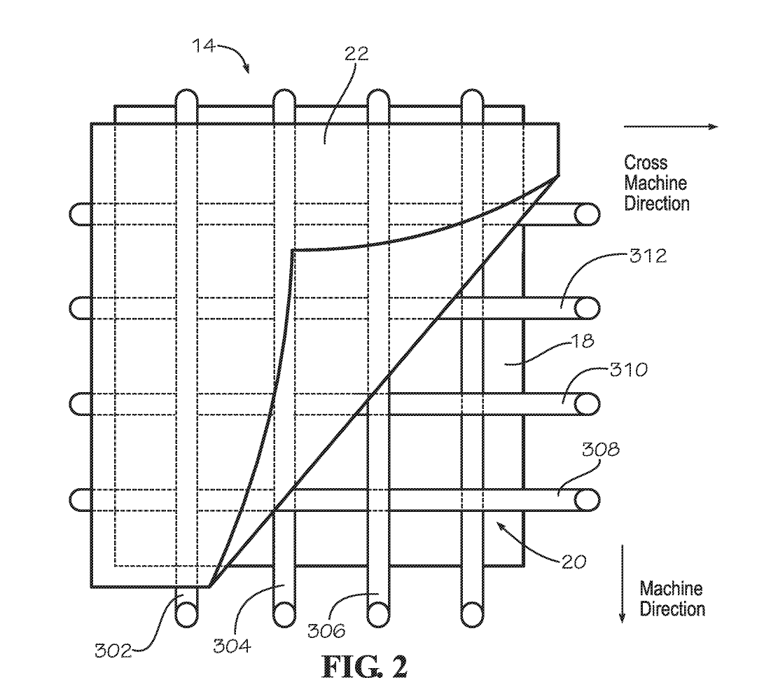

FIGS. 2, 5 and 6 show a disclosed embodiment of a preferred laminated fabric, which can be used as the first layer of laminated fabric membrane 14 and optionally as the second layer of laminated fabric 16. The laminated fabric membrane 14 can also be used in the processes shown in FIGS. 3 and 4 as the laminated fabric 104 and the elastomeric polymer impregnated laminated fabric membrane 228. The laminated fabric membrane 14 comprises a laid scrim 20 having an open mesh or grid construction comprising a plurality of warp or machine direction yarns, such as the machine direction yarns 302, 304, 306, and a plurality of weft or cross direction yarns, such as the cross direction yarns 308, 310, 312. The machine direction yarns and the cross direction yarns of the laid scrim are bonded together at their intersection by means known in the art, such as by chemical bonding, heat bonding or mechanical stitching. As can be seen in FIG. 21, adjacent machine direction yarns, such as the yarns 304, 306, and adjacent cross direction yarns, such as yarns 308, 310, define a rectangular opening, such as the opening 314. The openings can be any suitable size, such as 0.05 inches×0.05 inches to 1 inch×1 inch, preferably approximately 0.2 inches×0.2 inches. The machine direction yarns can be spaced at approximately 1 yarn per inch to approximately 20 yarns per inch, preferably approximately 5 yarns per inch. Similarly, the cross direction yarns can be spaced at approximately 1 yarn per inch to approximately 20 yarns per inch, preferably approximately 5 yarns per inch. The machine direction yarns and the cross direction yarns can be made from the same materials or from different materials. The machine direction yarns and the cross direction yarns are made from materials having a high tensile strength and a high-modulus. The machine direction yarns and the cross direction yarns can be made from materials including, but not limited to, fiberglass, basalt fibers, aramid fibers, carbon fibers, polymers or polymer fibers.

As used herein, the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include thermoplastics, thermosetting resins and all possible geometrical configurations of their molecules. These configurations include, but are not limited to isotactic, syndiotactic and random symmetries.

Suitable polymers for use in the laid scrim 20 include, but are not limited to, polypropylene; polyethylene; polyethylene terephthalate; vinyl; polyvinyl chloride; polyester acrylic; nylon; Dyneema® (thermoplastic polyethylene, also known as ultra-high-molecular-weight polyethylene, high-modulus polyethylene or high-performance polyethylene, also usually having a molecular weight of approximately 2 to 6 million units); Spectra® (thermoplastic polyethylene, also known as ultra-high-molecular-weight polyethylene, high-modulus polyethylene or high-performance polyethylene, also usually having a molecular weight of approximately 2 to 6 million units); PBO Zylon® (poly(p-phenylene-2,6-benzobisoxazole), a thermosetting liquid crystalline polyoxazole); Vectran® (an aromatic polyester produced by the polycondensation of 4-hydroxybenzoic acid and 6-hydroxynaphthalene-2-carboxylic acid); Twaron® (p-phenylene terephthalamide or para polyaramide); aramids, such as Kevlar® (a para-aramid, the reaction product of 1,4-phenylene-diamine (para-phenylenediamine) and terephthaloyl chloride) and Nomex®; Innegra (a polyolefin, highly oriented polypropylene) and carbon fiber. Also suitable are natural fibers and high-modulus yarns. Chemical binders for the laid scrim 20 include, but are not limited to, thermoplastic and thermosetting polymers. Specifically, the binders for the laid scrim 20 include, but are not limited to, polyvinyl alcohols, polyvinyl chlorides, styrene butadiene rubber, ethylene-vinyl acetate, acrylics and the like.

As stated above, the machine direction yarns and the cross direction yarns of the reinforcing layer can be made from the same materials or from different materials. For example, the machine direction yarns can be made from carbon fibers and the cross direction yarns can be made from polymers or polymer fibers, such as polyester. Also, the carrier or transport layers can be made from the same material as the reinforcing layer or from different materials.

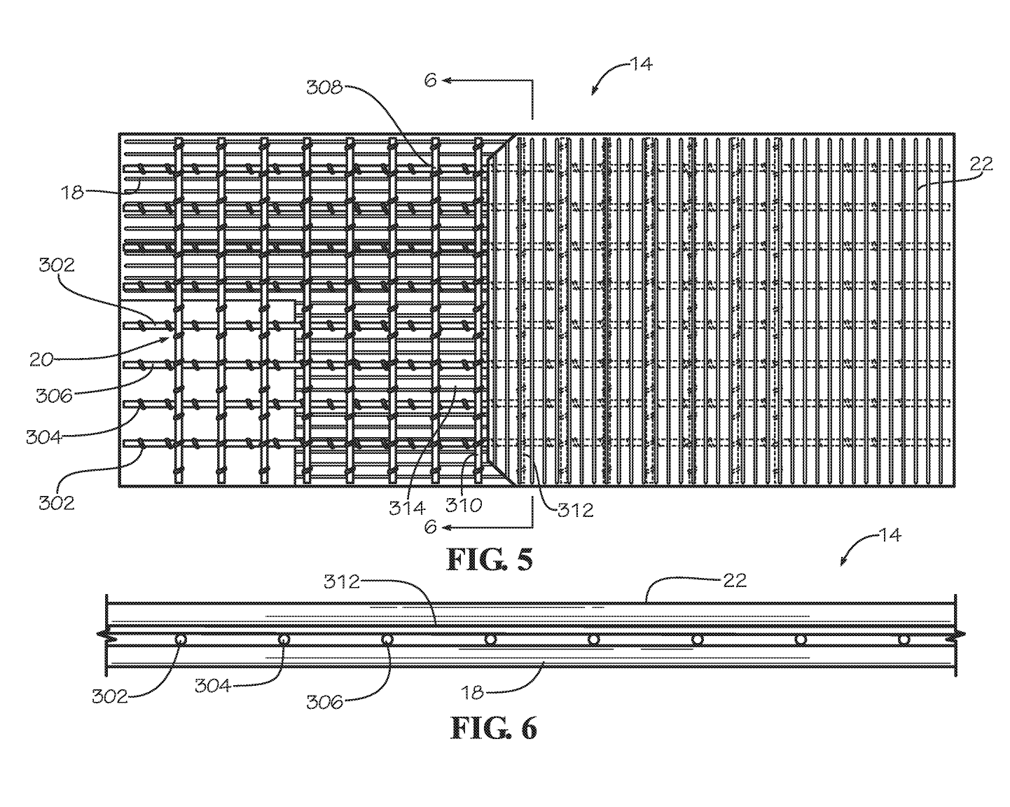

As shown in FIGS. 5 and 6, the laminated fabric membrane 14 also preferably includes a first woven or nonwoven carrier layer 18 and optionally a second woven or nonwoven carrier 22. The first and second carrier layers 18, 22 are then chemically, thermally or physically bonded to the laid scrim 20. Suitable materials for the woven or nonwoven carrier layers 18, 22 include, but are not limited to, polypropylene, polyethylene, polyethylene terephthalate, vinyl, polystyrene, polyvinyl chloride, polyester, acrylic, nylon, rayon, acetate, spandex, lastex, aramid fibers, fiberglass or mixtures or combinations thereof. A particularly preferred material for the carrier layers 18, 22 is nonwoven fiberglass.

Nonwoven fabrics are broadly defined as sheet or web structures bonded together by entangling fiber or filaments (and by perforating films) mechanically, thermally or chemically. They are flat or tufted porous sheets that are made directly from separate fibers, molten plastic or plastic film. They are not made by weaving or knitting and do not require converting the fibers to yarn. Nonwoven fabrics provide specific functions such as liquid repellence, strength, flame retardancy, thermal insulation, acoustic insulation, and filtration. Nonwovens are typically manufactured by putting small fibers together in the form of a sheet or web (similar to paper on a paper machine), and then binding them either mechanically (as in the case of felt, by interlocking them with serrated needles such that the inter-fiber friction results in a stronger fabric), with an adhesive, or thermally (by applying binder in the form of powder, paste, or polymer melt and melting the binder onto the web by increasing temperature).

Staple nonwovens are made in four steps. Fibers are first spun, cut to a few centimeters in length, and put into bales. The staple fibers are then blended, “opened” in a multistep process, dispersed on a conveyor belt, and spread in a uniform web by a wetlaid, airlaid, or carding/crosslapping process. Wetlaid operations typically use ¼″ to ¾″ long fibers, but sometimes longer if the fiber is stiff or thick. Airlaid processing generally uses 0.5″ to 4.0″ fibers. Carding operations typically use ˜1.5″ long fibers. Rayon used to be a common fiber in nonwovens, now greatly replaced by polyethylene terephthalate (PET) and polypropylene (PP). Fiberglass is wetlaid into mats. Synthetic fiber blends are wetlaid along with cellulose. Staple nonwovens are bonded either thermally or by using resin. Bonding can be throughout the web by resin saturation or overall thermal bonding or in a distinct pattern via resin printing or thermal spot bonding. Conforming with staple fibers usually refers to a combination with meltblown. Meltblown nonwovens are produced by extruding melted polymer fibers through a spinneret or die consisting of up to 40 holes per inch to form long thin fibers which are stretched and cooled by passing hot air over the fibers as they fall from the die. The resulting web is collected into rolls and subsequently converted to finished products. The extremely fine fibers (typically polypropylene) differ from other extrusions, particularly spun bond, in that they have low intrinsic strength but much smaller size offering key properties. Often meltblown fibers are added to spun bond fibers to form SM or SMS webs, which are strong and offer the intrinsic benefits of fine fibers, such as acoustic insulation.

Nonwovens can also start with films and fibrillate, serrate or vacuum-form them with patterned holes. Fiberglass nonwovens are of two basic types. Wet laid mat or “glass tissue” use wet-chopped, heavy denier fibers in the 6 to 20 micrometer diameter range. Flame attenuated mats or “batts” use discontinuous fine denier fibers in the 0.1 to 6 range. The latter is similar, though run at much higher temperatures, to meltblown thermoplastic nonwovens. Wet laid mat is typically wet resin bonded with a curtain coater, while batts are usually spray bonded with wet or dry resin. An unusual process produces polyethylene fibrils in a Freon-like fluid, forming them into a paper-like product and then calendering them.

Both staple and spunlaid nonwovens would have no mechanical resistance in and of themselves, without the bonding step. Several methods can be used: thermal bonding, heat sealing using a large oven for curing, calendering through heated rollers (called spunbond when combined with spunlaid webs), calenders can be smooth faced for an overall bond or patterned for a softer, more tear resistant bond, hydro-entanglement (mechanical intertwining of fibers by water jets, often called spunlace), ultrasonic pattern bonding, needlepunching/needlefelting (mechanical intertwining of fibers by needles), and chemical bonding (wetlaid process—use of binders, such as latex emulsion or solution polymers, to chemically join the fibers, meltblown (fibers are bonded as air attenuated fibers intertangle with themselves during simultaneous fiber and web formation). Synthetic fabrics are man-made textiles rather than natural fibers. Some examples of synthetic fabrics are polyester, acrylic, nylon, rayon, acetate, spandex, lastex (yarn made from a core of latex rubber covered with fabric strands) and Kevlar® (aramid fibers). Synthetic fibers are made by the joining of monomers into polymers, by the process of polymerization. The fabric is made from chemically produced fibers. The chemicals are in liquid form and are forced through tiny holes called spinnerets. As the liquid comes out of the spinnerets and into the air, it cools and forms into tiny threads.

A particularly preferred material for the woven or nonwoven carrier layers 18, 22 or for the woven or nonwoven porous reinforcing fabric 16 is a woven fiberglass mesh, a woven fiberglass fabric and a nonwoven fiberglass mat available from JPS Composite Materials, Anderson, S.C., USA.

The laminated fabrics suitable for use in the present invention are commercially available under the designations Laid Scrim and Engineered Specialty Fabrics including, but not limited to, XP206, XP315, XP206, XPC137, XPC169 XPC138, XPC184, XPC187, XPC173 from Saint-Gobain ADFORS America, Inc., Grand Island, N.Y. 14072. Suitable materials for the laminated fabric membrane 14 are also disclosed in U.S. Publication Nos. 2013/0280476, 2013/0280477 and 2014/0290165 (the disclosures of which are all incorporated herein by reference in their entirety). A preferred material for the laid scrim 20 is a laid scrim commercially available from Saint-Gobain ADFORS America, Inc. under the designation XP414. This material is a side-by-side laid scrim having machine direction yarn and cross direction yarn made from 500 denier H.T. polyester. The machine direction and cross direction yarns are spaced at 5×5 yarns per inch and a weight of 2.45 ounces per yd². The laminated fabric includes a carrier layer on each primary surface made from nonwoven polyester at a weight of 0.4 ounces per yd². The chemical binder for this laminated fabric is fire resistant polyvinyl chloride (“F.R. PVC”).

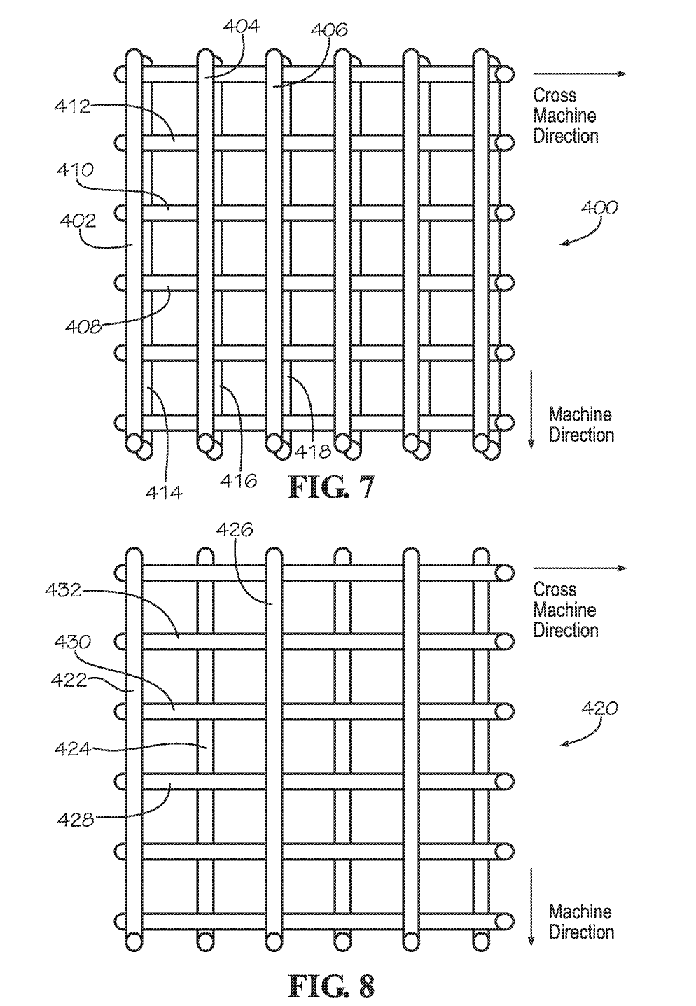

As stated above, the laid scrim can be made from yarns, filaments or strands of various material in various orientations. FIGS. 7-10 show laid scrims of some preferred orientations. Specifically, FIG. 7 shows a laid scrim 400 in a side-by-side orientation, which comprises a top layer of machine direction yarns, such as the yarns 402, 404, 406, and a layer of cross machine direction yarns, such as the yarns 408, 410, 412. Optionally, the side-by-side orientation can include a bottom layer of machine direction yearns, such as the yarns 414, 416, 418. In the side-by-side orientation, all of the machine direction yarns in the top layer cross all of the cross direction yarns on the same side. Additionally, the machine direction yarns cross the cross direction yarns at approximately 90° angles.

FIG. 8 shows a laid scrim 420 in the over/under orientation. The over/under orientation comprises machine direction yarns, such as the yarns 422, 424, 426, and cross direction yarns, such as the yarns 428, 430, 432. Specifically, the alternating machine direction yarns, such as the yarns 422, 426, cross the cross direction yarns, such as the yarns 428, 430, 432 on the same side and the other machine direction yarns, such as the yarn 424, cross the cross machine direction yarns, such as the yarns 428, 430, 432 on the opposite side. Additionally, the machine direction yarns cross the cross direction yarns at 90° angles.

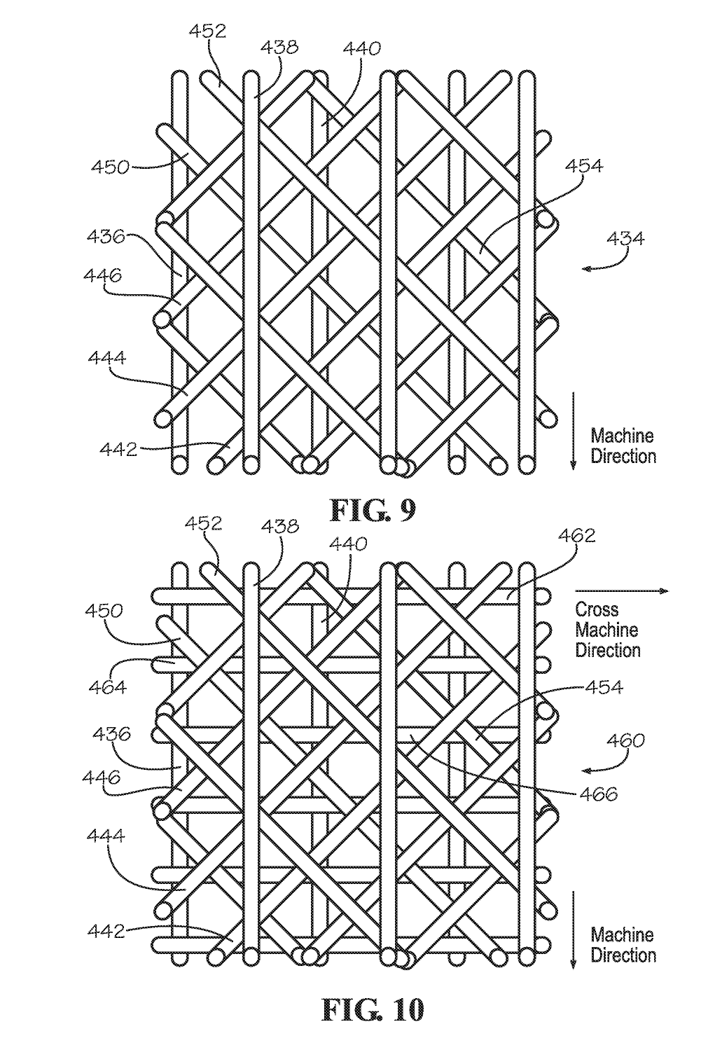

FIG. 9 shows a laid scrim 434 in the tri-directional orientation. The tri-directional orientation comprises a plurality of machine direction yarns, such as the yarns 436, 438, 440; a plurality of a first set of diagonal yarns, such as the yarns 442, 444, 446 and a second set of a plurality of yarns of the diagonal yarns of the opposite orientation, such as the yarns 450, 452, 454. The first set of diagonal yarns, such as the yarns 442, 444, 446, and the second set of diagonal yarns, such as the yarns 450, 452, 454, are arranged in an over/under configuration. That is alternate yarns of the second set of diagonal yarns, such as the yarns 450, 454, cross the first set of diagonal yarns, such as the yarns 442, 444, 446, on the same side of the first set of diagonal yarns; whereas, the other yarn of the second set of diagonal yarns, such as the yarn 452, cross the first set of diagonal yarns on the opposite side. Additionally, the first set of diagonal yarns, such as the yarns 442, 444, 446, and the second set of diagonal yarns, such as the yarns 450, 452, 454, intersect each other at approximately 90° angles. Furthermore, the alternate machine direction yarns, such as the yarns 436, 440, are on one side of the first and second sets of diagonal yarns, such as the yarns 442, 444, 446, 450, 452, 454. The other machine direction yarns, such as the yarn 438, are on the other side of the first and second sets of diagonal yarns.

FIG. 10 shows a laid scrim 460 in the quad-direction orientation. The quad-direction orientation is the same as the tri-direction orientation, but with cross direction yarns added. The cross machine direction yarns, such as the yarns 462, 464, 466, are disposed between the alternate machine direction yarns, such as the yarns 436, 440, and the first and second sets of diagonal yarns, such as the yarns 442, 444, 446, 450, 452, 454.

The multi-directionally oriented yarns in the open mesh of the reinforcing layer described above with respect to FIGS. 9 and 10 can provide additional structural reinforcement to enhance the structural properties of the laminated fabric 14 and the composite foam insulated sheathing board 10.

It is specifically contemplated as a part of the present invention that the polyisocyanurate foam or polyurethane foam from which the foam core 12 is made can include heat reflective additives, especially infrared heat reflective additives. The polyisocyanurate or polyurethane foam in accordance with the present invention include approximately 0.1% to approximately 10% by weight refractory material, preferably approximately 0.1% to 5% by weight. Refractory insulating material is typically made from ceramic fibers made from materials including, but not limited to, silica, silicon carbide, alumina, aluminum silicate, aluminum oxide, zirconia, calcium silicate; glass fibers, mineral wool fibers, Wollastonite and fireclay. Refractory insulating material is commercially available in various form including, but not limited to, bulk fiber. Ceramic fibers are fibers made from materials including, but not limited to, silica, silicon carbide, alumina, aluminum silicate, aluminum oxide, zirconia, calcium silicate and mixtures or combinations thereof. Wollastonite is an example of a ceramic fiber. The above fibers can be used in any number of ways and combination percentages, not just as a single element added to the polyisocyanurate or polyurethane. Wollastonite is a calcium inosilicate mineral (CaSiO₃) that may contain small amounts of iron, magnesium, and manganese substituted for calcium. Wollastonite is available from NYCO Minerals of NY, USA. Bulk ceramic fibers are available from Unifrax I LLC, Niagara Falls, N.Y., USA. Ceramic fibers are known to block heat transmission and especially radiant heat. Ceramic fibers can help improve the energy efficiency and fire resistance of the insulated foam panel.

Polyisocyanurate is made from a thermosetting catalyzed plastic reaction product. Polyisocyanurate is made from the reaction of methylene diphenyl diisocyanate (“MDI”) and a polyester-derived polyol in the presence of a catalyst. Polyisocyanurate foam is made from the foregoing ingredients and a blowing agent, a foaming agent or a frothing agent. The refractory material is added to either the MDI or the polyol before the polyisocyanurate-forming reaction or before the blowing, the foaming or the frothing.

Polyurethane is made from the reaction of a di- or polyisocyanate with a polyol in the presence of a catalyst. Polyurethane foam is made from the foregoing ingredients and a blowing agent, a foaming agent or a frothing agent. The refractory material is added to either the di- or polyisocyanate or the polyol before the polyurethane-forming reaction or before the blowing, the foaming or the frothing.

Other fillers or additives may also be added, such as non-glass filler materials including, but not limited to, clay, mica, talc, limestone (calcium carbonate), gypsum (Calcium sulfate), aluminum trihydrate (“ATH”), antimony oxide, cellulose fibers and plastic polymer fibers.

The polyisocyanurate or polyurethane composition can also contain one or more infrared attenuating agents as disclosed in U.S. Pat. No. 8,754,143 (the disclosure of which is incorporated herein by reference in its entirety), such as graphite or nanographite. The polyisocyanurate or polyurethane composition can also contain carbon black, magnetite, aluminum flakes or a combination thereof as infrared attenuating agents, in an amount effective to reflect infrared heat, preferably in an amount of approximately 0.1% to approximately 20% by weight, more preferably in an amount of approximately 0.1% to approximately 10% by weight.

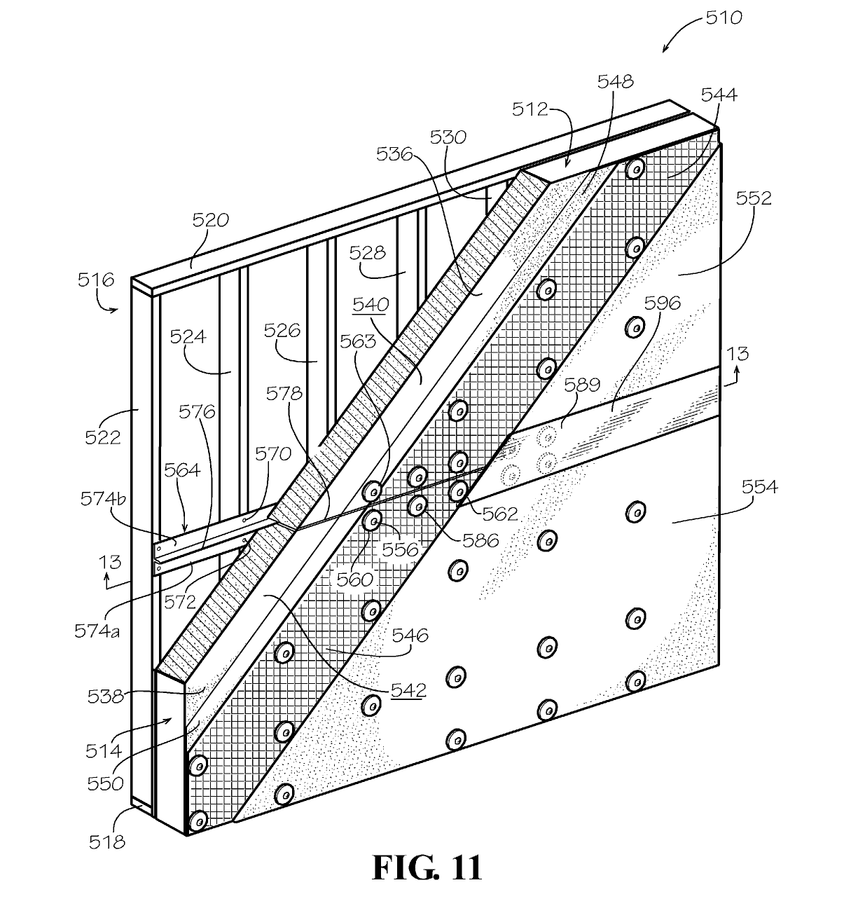

FIGS. 11-13 show a disclosed embodiment of an insulated sheathing system 500 in accordance with the present invention. The insulated sheathing system 500 includes a first composite insulated sheathing board 512 and a second composite insulated sheathing board 514 attached to a conventional stud wall 516.

The stud wall 516 comprises a horizontal bottom track 518 and a horizontal top track 520. Disposed between the bottom track 518 and the top track 520 are a plurality of vertical studs 522, 524, 526, 528, 530. The vertical studs 522-530 are typically made from 2″×4″ or 2″×6″ pine and usually in lengths of 8 feet, 9 feet or 10 feet. The vertical studs 522-530 shown in FIG. 11 are 2″×4″×8′. Although the vertical studs 522-530 are shown as being made from wood, other materials including, but not limited to, metal, such as steel or aluminum, or composite materials can be used for the vertical studs.

Each of the composite insulated sheathing boards 512, 514 comprises a rectangular foam insulating panel 536, 538. The foam insulating panels 536, 538 can be made from any thermosetting catalyzed plastic reaction product that is sufficiently rigid to withstand anticipated wind loads. The foam insulating panels 536, 538 preferably are made from a closed cell thermosetting polymeric foam material, such as polyisocyanurate foam or polyurethane foam. The foam insulating panels 536, 538 should be at least 0.5 inches thick, preferably approximately 1 inch thick, more preferably approximately 2 to approximately 8 inches thick, especially at least 2 inches thick; more especially at least 3 inches thick, most especially at least 4 inches thick. The foam insulating panels 536, 538 should have insulating properties of approximately R-2, preferably approximately R-4, more preferably approximately R-8 most preferably approximately R-16, especially greater than R-4, more especially greater than R-8, most especially greater than R-16.

The foam insulating panels 536, 538 should also have a density sufficient to make them substantially rigid, such as approximately 2 to approximately 8 pounds per cubic foot, preferably approximately 6 pounds per cubic foot. The foam insulating panels 536, 538 can be made by casting or molding to the desired size and shape. Although the foam insulating panels 536, 538 can be of any desired size and thickness, it is specifically contemplated that the foam insulating panels will conveniently be 4 feet wide and 8 feet long, 4 feet wide and 10 feet long or 4 feet wide and 12 feet long and 4 inches thick. Polyisocyanurate foam board faced with nonwoven glass fibers is available under the designation ACFoam® from Atlas Roofing Corp., Byron Center, Mich. 49315 and under the designation Valuetherm from Denver, Colo. 80217. Polyurethane foam board is available under the designation Last-A-Foam® from General Plastics Manufacturing Company, Tacoma, Wash. 98409.

Applied to the exterior surface (a first primary surface) 540, 542 of each of the foam insulating panel 536, 538, respectively, is a laminated fabric 544, 546, respectively. The laminated fabric 544, 546 make the foam insulating panels 536, 538 more rigid, allow for embedment and gauge the thickness of the weather membrane polymer. They can also assist in attaching the foam insulating panels to a building structure and attaching exterior finishes to the foam insulating panels. The laminated fabric 544, 546 is preferably the same as the elastomeric polymer impregnated laminated fabric membrane 14.

The laminated fabric 544, 546 is adhered to the exterior surfaces 540, 542 of each of the foam insulating panels 536, 538, respectively (if not made by the process described in association with FIG. 4). It is preferred that the laminated fabric 544, 546 is laminated to the exterior surfaces 540, 542 of the foam insulating panel 536, 538 using a polymeric elastomeric material that forms an air barrier on the exterior surface of the foam insulating panels, but also allows a desired amount of vapor permeability, but does not allow air transmission; i.e., the same material as the weather membrane polymer described above. Vapor permeable air barrier layers 548, 550 can be applied to the exterior surfaces 540, 542 of the foam insulating panels 536, 538, respectively, by any suitable method, such as by spraying, brushing or rolling, and then applying the layers of reinforcing material 544, 546 thereto. Alternately, the laminated fabric 544, 546 can be applied to the exterior surfaces 540, 542 of the foam insulating panels 536, 538, respectively, and then the vapor permeable air barrier layers 552, 554 can be applied to the layers of reinforcing material by any suitable method, such as by spraying, brushing or rolling. Preferably, the elastomeric vapor permeable air barrier layers 548, 550 can be applied to the exterior surfaces 540, 542 of the foam insulating panels 536, 538, respectively, and then the laminated fabric 544, 546 can be applied to the elastomeric vapor permeable air barrier layers 551, 554 followed by the vapor permeable air barrier layers 552, 554 applied to the laminated fabric. The elastomeric vapor permeable air barrier layers 548, 550 can be applied as the laminating agent for the laminated fabric 544, 546 or it can be applied in addition to an adhesive used to adhere the laminated fabric to the exterior surfaces 540, 542 of the foam insulating panels 536, 538. Preferably, the laminated fabric 544, 546 are at least partially embedded in the elastomeric vapor permeable air barrier layers 548-554. More preferably, the laminated fabric 544, 546 is impregnated with the elastomeric vapor permeable air barrier layers 548, 550 and/or 552, 554. Suitable polymeric materials for use as the vapor permeable air barrier layers 548-554 are any air-resistant, water-resistant, vapor permeable elastomeric polymeric material that is compatible with both the material from which the laminated fabric 544, 546 and the foam insulating panels 536, 538 are made; especially, liquid applied polymeric elastomeric vapor permeable air barrier membrane materials and have the properties regarding vapor permeability, air permeance and elongation set forth herein.

A preferred vapor permeable air barrier membrane 548-554 is made from a combination of the liquid vapor permeable air barrier membrane material, such as a polymeric elastomeric coating, and 0.1% to approximately 50% by weight ceramic fibers, preferably 0.1% to 40% by weight, more preferably 0.1% to 30% by weight, most preferably 0.1% to 20% by weight, especially 0.1% to 15% by weight, more especially 0.1% to 10% by weight, most especially 0.1% to 5% by weight. Ceramic fibers are fibers made from materials including, but not limited to, silica, silicon carbide, alumina, aluminum silicate, aluminum oxide, zirconia, calcium silicate and mixtures or combinations thereof. Wollastonite is an example of a ceramic fiber. The above fibers can be used in any number of ways and combination percentages, not just as a single element added to the elastomeric material. Wollastonite is a calcium inosilicate mineral (CaSiO₃) that may contain small amounts of iron, magnesium, and manganese substituted for calcium. Wollastonite is available from NYCO Minerals of NY, USA. Bulk ceramic fibers are available from Unifrax I LLC, Niagara Falls, N.Y., USA. Ceramic fibers are known to block heat transmission and especially radiant heat. Ceramic fibers can help improve the energy efficiency and fire resistance of the elastomeric vapor permeable air barrier membrane and of the composite insulated foam panel.

Optionally, Wollastonite, other mineral oxides, such as magnesium oxide and aluminum oxide, fly ash, rice husk ash or fire clay or any other fire resistant fillers, can be added to the vapor permeable air barrier membrane material, in the above mentioned quantities, to both increase resistance to heat transmission, improve radiant heat insulation properties and act as a fire retardant. Therefore, the elastomeric vapor permeable air barrier materials can obtain fire resistance properties. A fire resistant vapor permeable air barrier membrane over the exterior surface of the foam insulating panel can increase the fire rating of the wall assembly and delay the melting of the foam insulating panels.

Alternatively, the vapor permeable air barrier membrane 548-554 can be made from a combination of the liquid vapor permeable air barrier membrane material, such as a polymeric elastomeric coating, and approximately 0.1% to approximately 15% by weight heat reflective elements, preferably approximately 0.1% to approximately 10% by weight, more preferably approximately 0.1% to approximately 5% by weight. Heat reflective elements are made from materials including, but not limited to, mica, aluminum flakes, magnetite, graphite, carbon, other types of silicates and mixtures or combinations thereof. The above heat reflective elements can be used in any number ways and combination percentages, not just as a single element added to the elastomeric material. The heat reflective elements can also be used in conjunction with the ceramic fibers mentioned above in any number of ways and percentage combinations. The vapor permeable membrane will thus have infrared or heat reflective properties for improved insulating and energy efficiency properties. Preferably, the vapor permeable air barrier layers 548, 550 and/or 552, 554 are water resistant. Vapor permeable weather and air barriers have to allow the desired amount of vapor transmission under pressure differential but have to stop the water infiltration into the building envelope. It is also preferred that the air barrier layers 548, 550 and/or 552, 54 are vapor permeable. Thus, the vapor permeable air barrier layers 548, 550 and/or 552, 554 provide an air barrier, but not a vapor barrier. The vapor permeable air barrier layers 548, 550 and/or 552, 554 preferably have a water vapor transmission rating of at least 0.1 perm (1.0 US perm=1.0 grain/square-foot hour inch of mercury 57 SI perm=57 ng/s·m2·Pa) (ASTM E96), preferably at least 1 perm, more preferably at least 5 perms, most preferably at least 10 perms. The vapor permeable air barrier layers 548, 550 and/or 552, 554 should have a an elongation factor of greater than 100%, preferably greater than 200%, more preferably greater than 300%, most preferably greater than 400%, especially greater than 500%, more especially greater than 600%, most especially greater than 700% and an air permeance of less than 0.004 cfm/sq. ft. under a pressure differential of 0.3 in. water (1.57 psf) (equal to 0.02 L/s.×sq. m. @ 75 Pa). Air permeance is measure in accordance with ASTM E2178. The composite insulated panels 512, 514 should have an assembly air permeance of less than 0.04 cfm/sq. ft. of surface area under a pressure differential of 0.3 in. water (1.57 psf) (equal to 0.2 L/s.×sq. m. of surface area at 75 Pa) when tested in accordance with ASTM E2357. The vapor permeable air barrier layers 548, 550 and/or 552, 554 can be latex, elastomeric, acrylic, and may or may not have fire resistive properties. Air permeance is the amount of air that migrates through a material. Useful liquid applied weather membrane materials include, but are not limited to, Air-Shield LMP by W.R. Meadows, Cartersville, Ga., USA, (a vinyl acetate and ethylene glycol monobutyl ether acetate water-based air/liquid elastomeric vapor permeable air barrier that cures to form a tough, seamless, elastomeric membrane); Perm-A-Barrier VP 20 by Grace Construction Products, W.R. Grace & Co. (a fire-resistive, one component, fluid-applied elastomeric vapor permeable air barrier membrane that protects building envelope from air leakage and rain penetration, but allow the walls to “breathe”); and Tyvek Fluid Applied WB System by E.I. du Pont de Nemours and Company, Wilmington, Del., USA (a fluid applied weather barrier, vapor permeable system). Air-Shield LMP has an air permeability of <0.04 cfm/ft² @ 75 Pa (1.57 lbs/ft²) (ASTM E2357), an air permeability of <0.004 cfm/ft² @ 75 Pa (1.57 lbs/ft²) (ASTM E2178), water vapor permeance of 12 perms (ASTM E96) and an elongation of 1000% (ASTM D412). Perm-A-Barrier VP 20 has an air permeance of <0.0006 cfm/ft² @ 1.57 psf (0.003 L/s·m² @ 75 Pa) (ASTM E2178).

The foregoing procedure is used for constructing the composite insulated sheathing boards 512, 514 that have not been made by the process described above with respect to FIGS. 1-4. If composite insulated sheathing boards have been made by the process described in association with FIGS. 1-4, such as the composite insulated sheathing board 266, it can be substituted for the composite insulated sheathing boards 512, 514.

The composite insulated sheathing boards 512, 514 therefore comprise the foam insulating panels 536, 538, the attached laminated fabric 544, 546 and the associated elastomeric vapor permeable air barrier layers 548, 550 and/or 552, 554, respectively.

The foregoing procedure is used for constructing the composite insulated sheathing boards 512, 514 that have not been made by the process described above with respect to FIGS. 1-4. However, it is preferred that composite insulated sheathing boards, such as the composite insulated sheathing board 266, be used for the composite insulated sheathing boards 512, 514.

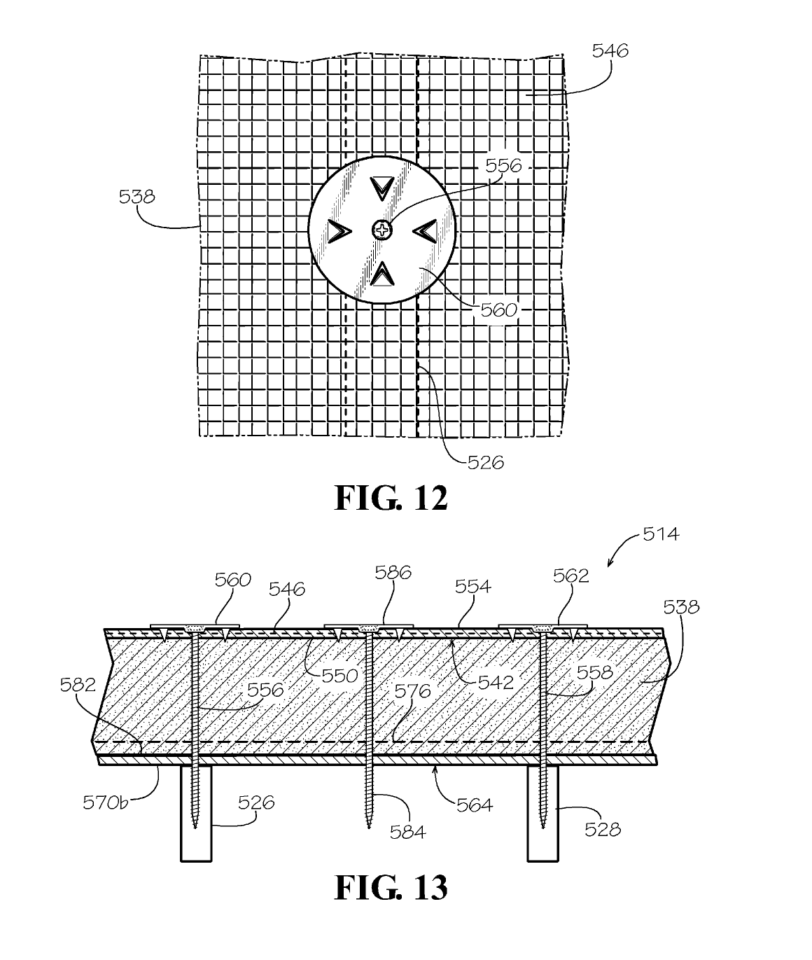

The composite insulated sheathing boards 512, 514 are attached to the vertical studs 522-530 by a plurality of screws vertically and horizontally spaced from each other, such as by the screws 556, 558 and associated washers, such as the circular washers 560, 562, 563 (FIGS. 1, 3 and 4). The washers 560, 562 can be made from plastic or preferably are made from metal. Although the washers 560, 562 have been shown in FIGS. 12 and 13 as having spikes or cleats extending outwardly from the washer body, it is specifically contemplated the conventional washers can also be used in the present invention.

As can be seen in FIGS. 12 and 13, at least a portion of the laminated fabric 546 is disposed between the washers 560, 562 and the exterior primary surface 546 of the foam insulating panel 538. To achieve effective structural properties and to resist the positive or negative structural loads that are imposed on the composite insulated sheathing boards 512 and 514 and for the load to be safely transferred to the structure, the screws 556, 558 penetrate through the elastomeric vapor permeable air barrier layers 538 and/or 554, through the laminated fabric 546, through the foam insulating panel 538 and into the studs 526, 528. By capturing the layer of reinforcing material 546 between the exterior surface 542 of the foam insulating panel 538 and each of the washers 560, 562, the structural loads exerted on the foam insulating panel are distributed over a wider area than just the area of the washer; it is also at least partially transferred to the layer of reinforcing material. Notably, none of the laminated fabric 546 covers the screws 556, 558 and the associated washers 560, 562. Such would be counterproductive to the principle of transferring the retaining force of the screws 556, 558 and the associated washers 560, 562 to the laminated fabric 546. Without the screws 556, 558 and the associated washers 560, 562 over the laminated fabric 544, 550 the foam insulating panel 538 will fail. Also, the composite insulated sheathing boards 514 with an impregnated laminated fabric creates a structurally strong foam panel that can resist the structural loads associated with the exterior of a building. A foam panel laminated with films or foils, such as polyethylene film or aluminum foil, are not as strong as a composite insulated sheathing boards 266 in accordance with the present invention.

Optionally, but preferably, before the composite insulated sheathing boards 512, 514 are attached to the wall studs 522-530, a T-bar or elongate reinforcing element 564 is attached horizontally to at least two adjacent wall studs, such as the wall studs 522 and 524, but preferably to a plurality of wall studs, as shown in FIG. 11, by for example, screws 566, 568 (FIG. 5) and screws 570, 572 (FIG. 1). The elongate reinforcing element 564 is preferably made from metal, such as steel or aluminum. The elongate reinforcing element 564 preferably has a cross-sectional T-shape. The elongate reinforcing element 564 preferably comprises flat elongate body members 574a, 574b and a central longitudinal leg or projection 576 extending outwardly from the body member. The elongate body members 574a, 574b preferably both are in the same plane and the projection 576 is orthogonal to that plane. The elongate body members 574a, 574b can be any useful width, but preferably are each approximately 0.5 to 4 inches wide, especially approximately 1 inch wide. The elongate reinforcing element 564 can be any useful length, but preferably is approximately 8 feet long, more preferably approximately 10 feet long and most preferably approximately 12 feet long. The elongate reinforcing element 564 is preferably made by roll forming an elongate, flat piece of metal, especially steel or aluminum. By attaching the elongate reinforcing element 564 to adjacent stud, such as the studs 522-520, the elongate reinforcing element provides horizontal shear and buckling resistance to the studs and eliminates or reduces, the requirement for separate horizontal shear reinforcement, such as shear-studs, horizontal struts, noggins, dwangs or blocking. It especially eliminates the use of structural sheathing materials, such a plywood or OSB, typically used to provide the structural shear and buckling reinforcement for exterior walls.

The foam insulating panels 536, 538 are positional with their edges adjacent each other thereby forming a joint 578 therebetween, preferably a longitudinal joint (FIG. 11). Each of the foam insulating panels 536, 538 has an interior surface (a second primary surface) 580, 582 opposite the exterior surfaces 540, 542, respectively. The elongate reinforcing element 564 is positioned so that the projection 576 extends at least partially into the joint 578 between the foam insulating panels 536, 538. The elongate reinforcing element 564 is also positioned so that the body portion 574a at least partially covers a portion of the interior surface 580 of the foam insulating panel 536 and so that the body portion 574b at least partially covers a portion of the interior surface 82 of the foam insulating panel 538. The elongate reinforcing element 564 therefore also reduces, or prevents, water intrusion that may be caused by water getting blown through the joint 578 between the adjacent foam insulating panels 536, 538. The elongate reinforcing element 564 also provides and additional anchoring for the foam insulating panels 536, 538 between adjacent studs, such as between the studs 526, 528 (FIG. 13). For example, a screw 584 and washer 586 can be positioned such that the screw penetrates the foam insulating panel 538 and into the body portion 570b of the elongate reinforcing element 564.

After the washers 560, 562, 563, 586 are anchored to the studs, such as the studs 526, 528, a strip of reinforcing material 589 is applied over the joint 578 between the adjacent composite insulated sheathing boards 512, 514 and over the washers (FIG. 11). The strip of reinforcing material 589 is preferably made from the same material as the laminated fabric 544, 546 or any other type of compatible material. The strip of reinforcing material 589 extends the length of the composite insulated sheathing boards 512, 514 and is wide enough to completely cover the washers 560, 562, 563, 586 (FIG. 11). The strip of reinforcing material 589 is adhered to the composite insulated sheathing boards 512, 514 preferably by applying to the strip of laminated fabric an elastomeric vapor permeable air barrier layer 591 made from the same material as the elastomeric vapor permeable air barrier layers 548, 550 and/or 552, 554 so that the strip of laminated fabric is at least partially embedded in the elastomeric vapor permeable air barrier layer. This provides an elastomeric vapor permeable air barrier over the joint 578 between the adjacent composite insulated sheathing boards 512, 514 to eliminate the air infiltration or exfiltration. However, a conventional water resistant adhesive compatible with the elastomeric membrane can also be used to adhere the strip of laminated fabric 578 to the composite insulated sheathing boards 512, 514.

Extruded polystyrene foam boards have a vapor permeability of approximately 1 Perm. Expanded polystyrene foam boards have a vapor permeability of approximately 3.5 Perms. Other types of foam boards have lower vapor permeabilities. In many cases, it is desirable to increase the vapor permeability of the insulating foam board. To increase the vapor permeability of the foam board perforation can be made in the foam panel in the manner disclosed in applicant's U.S. Pat. No. 8,966,845 (the disclosure of which is incorporated herein by reference in its entirety). By laminating the reinforcing material over the perforations the foam board does not lose any of it physical properties.

FIG. 11 shows the composite insulated sheathing boards 512, 514 attached directly to the studs 522-530. However, a layer of plywood, gypsum board or other sheathing material (not shown) optionally can be disposed between the composite insulated sheathing boards 512, 514 and the wall studs 522-530, as shown in applicant's U.S. Pat. No. 8,966,845 (the disclosure of which is incorporated herein by reference in its entirety).

It is specifically contemplated that the elastomeric polymer impregnated laminated fabric, as described above with reference to FIGS. 2 and 3, can be used with preformed insulating panels made from expanded or extruded polystyrene foam, polyisocyanurate foam or polyurethane foam. With a premade foam panel, the elastomeric polymer impregnated laminated fabric is adhered to a primary surface of the foam insulating panel with any suitable adhesive, such as those used in the prior art to attach foils and films to foam boards. For example, the impregnated laminated fabric membrane 228 can be attached to the foam panels 536, 538 using the same type of adhesive used for the vapor permeable air barrier layers 548, 550 and/or 552, 554 described above or any other suitable adhesive.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A product comprising:
a foam insulating panel having a first primary surface and an opposite second primary surface;
a laminated fabric attached to the first primary surface of the foam insulating panel, wherein the laminated fabric is impregnated with an air-resistant, water-resistant, vapor permeable, elastomeric polymeric material, wherein the air-resistant, water-resistant, vapor permeable elastomeric polymeric material has an elongation factor of greater than 100%, a water vapor transmission rating of at least 0.1 perm and an air permeance of less than 0.004 cfm/sq. ft. under a pressure differential of 0.3 inches of water, whereby the air-resistant, water-resistant, vapor permeable elastomeric polymeric material provides a water-resistant, vapor permeable air barrier; and
wherein the laminated fabric comprises a woven or nonwoven carrier portion and a woven or nonwoven reinforcing portion attached to the carrier portion.

2. The product of claim 1, wherein the woven or nonwoven reinforcing portion comprises a laid scrim.

3. The product of claim 2, wherein the laid scrim is made from polypropylene; polyethylene; polyethylene terephthalate; vinyl; polyvinyl chloride; polyester acrylic; nylon; thermoplastic polyethylene having a molecular weight of approximately 2 to 6 million units; (poly(p-phenylene-2,6-benzobisoxazole); an aromatic polyester produced by the polycondensation of 4-hydroxybenzoic acid and 6-hydroxynaphthalene-2-carboxylic acid; p-phenylene terephthalamide; para polyaramide; the reaction product of 1,4-phenylene-diamine (para-phenylenediamine) and terephthaloyl chloride); the condensation product of monomers m-phenylenediamine and isophthaloyl chloride; highly oriented polypropylene, fiberglass, carbon fiber or mixtures or combinations thereof.

4. The product of claim 2, wherein the carrier portion is a nonwoven material made from a polypropylene, polyethylene, polyethylene terephthalate, vinyl, polystyrene, polyvinyl chloride, polyester, acrylic, nylon, rayon, acetate, spandex, lastex, aramid fibers or mixtures or combinations thereof.

5. The product of claim 2, wherein the carrier portion is made from a nonwoven fiberglass material.

6. The product of claim 2, wherein the laid scrim has a side-by-side, over/under, tri-directional or quad-directional configuration.

7. The product of claim 1, wherein the foam insulating panel is made from polystyrene, polyisocyanurate or polyurethane.

8. A method comprising:
applying an uncured thermal insulating polymer foam to a first primary surface of laminated fabric, wherein the laminated fabric is impregnated with an air-resistant, water-resistant, vapor permeable, elastomeric polymeric material, wherein the air-resistant, water-resistant, vapor permeable elastomeric polymeric material has an elongation factor of greater than 100%, a water vapor transmission rating of at least 0.1 perm and an air permeance of less than 0.004 cfm/sq. ft. under a pressure differential of 0.3 inches of water, whereby the air-resistant, water-resistant, vapor permeable elastomeric polymeric material provides a water-resistant, vapor permeable air barrier, and wherein the laminated fabric comprises a woven or nonwoven carrier portion and a woven or nonwoven reinforcing portion attached to the carrier portion; and
at least partially curing the thermal insulating polymer foam.

9. The method of claim 8, wherein the woven or nonwoven reinforcing portion comprises a laid scrim.

10. The method of claim 9, wherein the laid scrim is made from polypropylene; polyethylene; polyethylene terephthalate; vinyl; polyvinyl chloride; polyester acrylic; nylon; thermoplastic polyethylene having a molecular weight of approximately 2 to 6 million units; (poly(p-phenylene-2,6-benzobisoxazole); an aromatic polyester produced by the polycondensation of 4-hydroxybenzoic acid and 6-hydroxynaphthalene-2-carboxylic acid; p-phenylene terephthalamide; para polyaramide; the reaction product of 1,4-phenylene-diamine (para-phenylenediamine) and terephthaloyl chloride); the condensation product of monomers m-phenylenediamine and isophthaloyl chloride; highly oriented polypropylene, carbon fiber, fiberglass or mixtures or combinations thereof.

11. The method of claim 9, wherein the carrier portion is made from a nonwoven polypropylene, polyethylene, polyethylene terephthalate, vinyl, polystyrene, polyvinyl chloride, polyester, acrylic, nylon, rayon, acetate, spandex, lastex, aramid fibers, fiberglass or mixtures or combinations thereof.

12. The method of claim 9, wherein the carrier portion is made from a nonwoven fiberglass material.

13. The product of claim 9, wherein the laid scrim has a side-by-side, over/under, tri-directional or quad-directional configuration.

14. The product of claim 9, wherein the foam insulating panel is made from polystyrene, polyisocyanurate or polyurethane.

15. A product comprising:
a polyisocyanurate or polyurethane foam panel having a first primary surface and an opposite second primary surface, wherein the foam panel has a thickness of greater than or equal to 1 inch;
a laminated fabric attached to the first primary surface of the polyisocyanurate foam insulating panel, wherein the laminated fabric is impregnated with an air-resistant, water-resistant, vapor permeable, elastomeric polymeric material, wherein the air-resistant, water-resistant, vapor permeable elastomeric polymeric material has an elongation factor of greater than 100%, a water vapor transmission rating of at least 0.1 perm and an air permeance of less than 0.004 cfm/sq. ft. under a pressure differential of 0.3 inches of water, whereby the air-resistant, water-resistant, vapor permeable elastomeric polymeric material provides a water-resistant, vapor permeable air barrier; and
wherein the laminated fabric comprises a first nonwoven carrier layer having a primary surface, a laid scrim attached to the primary surface of the carrier layer and a second carrier layer attached to the laid scrim so that the laid scrim is disposed between the first and second nonwoven carrier layers.

16. The product of claim 15, wherein the first and second carrier layers are made from nonwoven fiberglass.

17. The product of claim 16, wherein the laid scrim has a side-by-side, over/under, tri-directional or quad-directional configuration.

18. The product of claim 17, wherein the laid scrim is made from polypropylene; polyethylene; polyethylene terephthalate; vinyl; polyvinyl chloride; polyester acrylic; nylon; thermoplastic polyethylene having a molecular weight of approximately 2 to 6 million units; (poly(p-phenylene-2,6-benzobisoxazole); an aromatic polyester produced by the polycondensation of 4-hydroxybenzoic acid and 6-hydroxynaphthalene-2-carboxylic acid; p-phenylene terephthalamide; para polyaramide; the reaction product of 1,4-phenylene-diamine (para-phenylenediamine) and terephthaloyl chloride); the condensation product of monomers m-phenylenediamine and isophthaloyl chloride; highly oriented polypropylene, carbon fiber, fiberglass or mixtures or combinations thereof.

19. The product of claim 18, wherein the laminated fabric is attached to the foam panel with a vapor permeable adhesive.
